(19) United States
(12) Patent Application Publication
(10) Pub. No.: US 2017/0068963 A1
(43) Pub. Date: Mar. 9, 2017

(54) SYSTEM AND A METHOD FOR LEAN METHODOLOGY IMPLEMENTATION IN INFORMATION TECHNOLOGY

(71) Applicant: HCL Technologies Limited, Uttar Pradesh (IN)

(72) Inventors: VIKAS SAXENA, Noida (IN); SHAILENDER SINGH, Noida (IN); PRADEEP SINGROHA, Noida (IN)

(21) Appl. No.: 15/216,660

(22) Filed: Jul. 21, 2016

(30) Foreign Application Priority Data
Sep. 4, 2015 (IN) 2783/DEL/2015

(51) Int. Cl. G06Q 30/00; G06Q 10/06

(52) U.S. Cl. CPC G06Q 30/016; G06Q 10/063112

(57) ABSTRACT

Disclosed is a method and system for providing a resolution to a ticket in an lean information technology framework. In one implementation the method comprises configuring a activity complexity database based on a plurality of low complexity activities identified across industry segments and technology tracks in an information technology framework. Further, receiving a ticket for resolution from a customer in the information technology framework, wherein the ticket comprises an issue, an error and a problem. Furthermore, classifying ticket as a low complexity activity or a non-low complexity activity based on a comparison of the ticket with the plurality of low complexity activities stored in the activity complexity database. Subsequently, assigning the ticket classified as the low complexity activity to a low complexity ticket team for providing a resolution to the ticket in the information technology framework, wherein the low complexity ticket team is one of a cross functional and cross technology team.

The present application claims the benefit of Indian Complete Patent Application No. 2783/DEL/2015, filed on Sep. 4 2015, the entirety of which is hereby incorporated by reference.

### TECHNICAL FIELD

The present subject matter described herein, in general, relates to a system and a method for lean information technology framework, and more particularly a system and a method for providing a resolution to a ticket in a lean information technology framework.

### BACKGROUND

Computers and software have become critical tools in today's information based society. Moreover, computers and software have provided tools to users to greatly increase work efficiencies. However, with the advantages provided by computers and software come technical problems associated with the computers and software applications. A typical solution to a computer and/or software technical problem is to contact technical support service of the company that provided the computer and/or software.

Now a day one of the challenges faced by any information technology company providing the computer and/or software relates to conventional delivery model of the support services. Further, the conventional support services delivery models are also facing the challenge to optimize the resource utilization across the company. In particular, a conventional delivery model fails at enabling accurate mapping of human resources, work experience, skill and work complexity to provide effective support services.

Generally, support services delivery models comprise technical support departments. Technical support departments are typically organized in a silo structure. More particularly, the silo structure is based on having a large number of specialists/subject matter experts segmented based on technology or industry. Such segmentation acts as a road block, because substantial amount of time is required to identify the team with the know-how in order to attempt to resolve the reported problem. The silo structure moreover restricts development of cross functional experience development of human resources. To add to it, there are unprecedented challenges in predicting the demand of resources or the amount of problems that may be reported in a given amount of time. The unpredictability thus makes precise capacity and sizing more difficult increasing the financial burden on the company.

### SUMMARY

Before the present system(s) and methods, are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application. This summary is provided to introduce aspects related to a system and a method for facilitating electronic learning of avoiding human errors within an organization. This summary is not intended to identify essential features of the claimed subject matter nor is it intended for use in determining or limiting the scope of the claimed subject matter.

In one implementation, a system for providing a resolution to a ticket in a lean information technology framework is disclosed. In one aspect, the system may configure an activity complexity database based on a plurality of low complexity activities identified across industry segments and technology tracks in an information technology framework. Upon configuring the activity complexity database, the system may receive a ticket for resolution from a customer in the information technology framework. The ticket may comprise at least one of an issue, an error and a problem being faced by the customer. Further to receiving the ticket, the system may classify the ticket as a low complexity activity or a non-low complexity activity based on a comparison of the ticket with the plurality of low complexity activities stored in the activity complexity database. Subsequently, the system may assign the ticket classified as the low complexity activity to a low complexity ticket team for providing a resolution to the ticket in the information technology framework. The low complexity ticket team is at least one of a cross functional and cross technology team.

In another implementation, a method for providing a resolution to a ticket in a lean information technology frame work is disclosed. In one aspect, the method may comprise configuring, an activity complexity database based on a plurality of low complexity activities identified across industry segments and technology tracks in an information technology framework. Upon configuring the activity complexity database, the method may further comprise receiving a ticket for resolution from a customer in the information technology framework. The ticket may comprise at least one of an issue, an error and a problem being faced by the customer. Further to receiving the ticket, the method may further comprise classifying the ticket as a low complexity activity or a non-low complexity activity based on a comparison of the ticket with the plurality of low complexity activities stored in the activity complexity database. Subsequently, the method may further comprise assigning the ticket classified as the low complexity activity to a low complexity ticket team for providing a resolution to the ticket in the information technology framework The low complexity ticket team is at least one of a cross functional and cross technology team.

In yet another implementation, non-transitory computer readable medium embodying a program executable in a computing device for providing a resolution to a ticket in a lean information technology frame work is disclosed. The program may comprise a program code for obtaining, first input data for one or more industry segments and one or more technology tracks, wherein the first input data comprises historical activities data, activities resolution trend data, activities time to resolve data, and activities average monthly volume. The program may comprise a program code for identifying the one or more low complexity activities for each of the industry segments and technology tracks based on the first input data and a predefined activities identification criterion, wherein the predefined activities identification criteria comprises type of environment, impact on environment, and time to resolve the activities. The program may comprise a program code for configuring an activity complexity database based on a plurality of low complexity activities identified across industry segments and technology tracks in an information technology framework. The program may comprise a program code for receiving a ticket for resolution from as customer in the information technology framework, wherein the ticket comprises at least one of an issue, an error and a problem being faced by the customer. The program may comprise a program code for classifying the ticket as a low complexity activity or a non-low complexity activity based on a comparison of the ticket with the plurality of low complexity activities stored in the activity complexity database. The program may comprise a program code for assigning the ticket classified as the low complexity activity to a low complexity ticket team for providing a resolution to the ticket in the information technology framework, wherein the low complexity ticket team is at least one of a cross functional and cross technology team; and. The program may comprise a program code for generating the resolution based on a low complexity resolution process for providing the resolution to the ticket, wherein the low complexity resolution process is executed by the low complexity ticket team.

### BRIEF DESCRIPTION OF THE DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a system for providing a resolution to a ticket in a lean information technology framework, in accordance with an embodiment of the present subject matter.

FIG. 2 illustrates the system for providing a resolution to the ticket in the lean information technology framework, in accordance with an embodiment of the present subject matter.

FIG. 3 illustrates a method for providing a resolution to the ticket in the lean information technology framework, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing, of embodiments of the present disclosure, the exemplary, system and methods are now described. The disclosed embodiments are merely examples of the disclosure, which may be embodied in various forms. Various modifications to the embodiment will be readily apparent to those skilled in the art and the genetic principles herein may be applied to other embodiments. However, one of ordinary skill in the art will readily recognize that the present disclosure is not intended to be limited to the embodiments described, but is to be accorded the widest scope consistent with the principles and features described herein.

In an implementation, a system and method for providing a resolution to a ticket in a lean information technology framework, is described. In the implementation, an activity complexity database may be configured. The activity complexity database may be configured based on a plurality of low complexity activities. In one example, the low complexity activities may be identified across industry segments, for example pharmaceutical, automobile and like. In one other example, the low complexity activities may be identified across technology tracks, for example UNIX™, Windows™ and like.

In the implementation, upon configuring the activity complexity database, a ticket for resolution from a customer may be received. In one example, the ticket may comprise an issue, an error and a problem being fixed by the customer, for example password not working.

In the implementation, further to receiving the ticket, the ticket may be classified as a low complexity activity or a non-low complexity activity. In one example, the classification may be based on a comparison of the ticket with the plurality of low complexity activities stored in the activity complexity database.

In the implementation, subsequent to classification of the ticket, the ticket if classified as the low complexity activity may be assigned to a low complexity ticket team for providing a resolution to the ticket. Further, the low complexity ticket team is a cross functional or cross technology team.

In the implementation, further to assigning of the ticket, the resolution may be generated. In one example, the resolution may be generated based on a low complexity resolution process for providing the resolution to the ticket. Further, the low complexity resolution process may be executed by the low complexity ticket team.

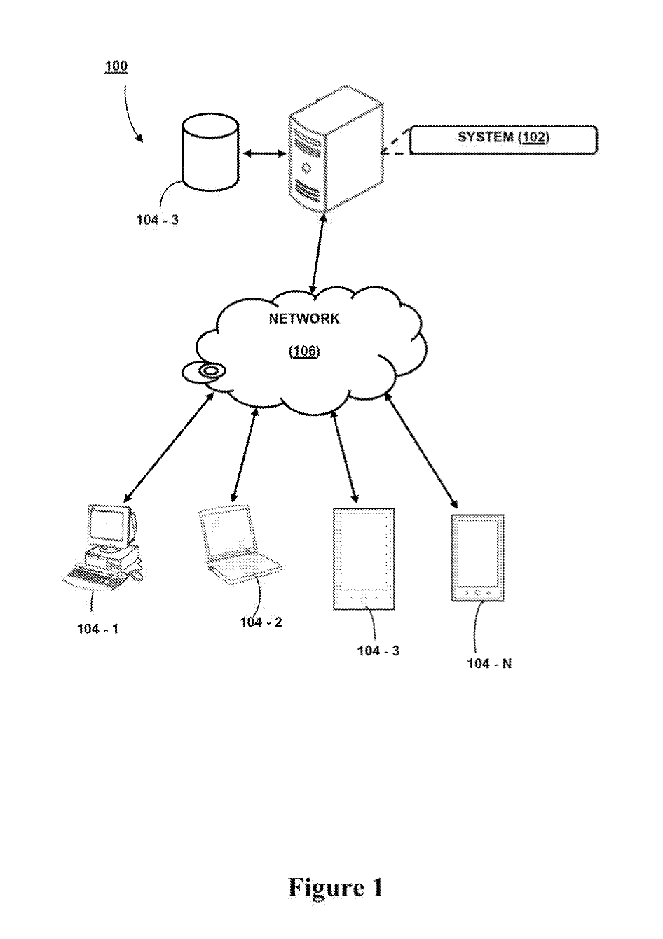

Referring now to FIG. 1, a network implementation of a system 102 for providing a resolution to a ticket in a lean information technology framework, in accordance with an embodiment of the present subject matter may be described. In one embodiment, the present subject matter is explained considering that the system 102 may be implemented as a standalone system connects to a network. It may be understood that the system 102 may also be implemented in a variety of computing systems, such as a laptop computer, a desktop computer, a notebook, a workstation, a mainframe computer, a server, a network server, a cloud-based computing environment and the like.

In one implementation, the system 102 may comprise the cloud-based computing environment in which the user may operate individual computing systems configured to execute remotely located applications. In another embodiment, the system 102 may also be implemented on client devices, hereinafter referred to as a user device 104. It may be understood that the system implemented on the client, device supports a plurality of browsers and all viewports. Examples of the plurality of browsers may include, but not limited to, Chrome™, Mozilla™, Internet Explorer™, Safari™, and Opera™. It will also be understood that the system 102 may be accessed by multiple users through one or more user devices 104-1, 104-2 . . . and 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

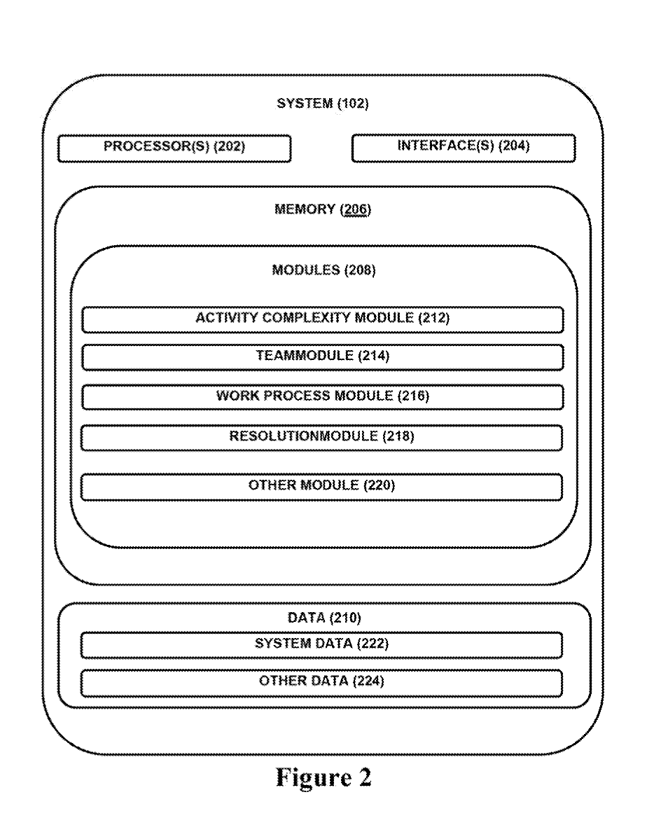

Referring now to FIG. 2 the system 102 for providing a resolution to a ticket in a lean information technology framework is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, bard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an activity complexity module 212, a team module 214, a work process module 216, a resolution module 218 and another module 220. The other modules 220 may include programs or coded instructions that supplement applications and functions of the system 102. The modules 208 described herein may be implemented as software modules that may be executed in the cloud-based computing environment of the system 102.

The memory 206, amongst other things, serves as a repository for storing data processed, received, and generated by one or more of the modules 208. The memory 206 may include data generated as a result of the execution of one or more modules in the other module 220. In one implementation, the memory may include data 210. Further, the data 210 may include a system data 222 for storing data processed, received, and generated by one or more of the modules 208. Furthermore, the data 210 may include other data 224 for storing data generated as a result of the execution of one or more modules in the other module 220.

In one implementation, the activity complexity module 212 may obtain first input data. In one example the first input data may comprise historical activities data, activities resolution trend data, activities time to resolve data, and activities average monthly volume data. In one example activities may be understood as the actions to be performed for support and maintenance of a software product. In the implementation the activity complexity module 212 may obtain first input data store the first input data in system data 222. In one example, activities trend may be 5 activities on every Monday, activities time to resolve may be 30 min per activity and activities average monthly volume may be 600 activities per month.

Further to obtaining, the activity complexity module 212 may identify the one or more low complexity activities for each of the industry segments and technology tracks based on the first input data and a predefined activities identification criterion. In one example, industry segments may be manufacturing, automobile, telecommunication, and pharmaceutical. In one other example, technology tracks may be LINUX™, UNIX™, CTRIX™, network, servers, backup, storage, exchange, tools, command center, account management, SAP™ basis and the like. The predefined activities identification criteria may comprises type of environment, impact on environment or client business, and time to resolve the activities. In one example, type of environment may be a production environment, a non-production environment, a client environment, impact on environment client business may be high medium or low, and time to resolve the activity may be 30 min. Table 1-20 lists the examples of low complexity activities identified from the activities data for various technology areas. In the implementation the activity complexity module 212 may identify the one or more low complexity activities and store the one or more low complexity activities in system data 222.

TABLE 1
Examples of low complexity activity in Wintel

| Sl. | | |
|---|---|---|
| No | Activity/Category/Task | Example of Ticket Summary |
| 1 | Space issue | Additional space required on SERVERNAME. |
| | | M:\SQLData1 and M:\SQLTempDB |
| 2 | Documentation tasks | Adding servers to password database |
| 3 | Reboot Activity | Critical-Unknown-Boot Alarm: Computer has been rebooted |
| | | at 2013.11.8 14:21:11 |
| 4 | Restart services | Restart the windows services on SERVERNAME |
| 5 | Device down | SERVERNAME is not accessible, |
| | | SERVERNAME Host Down 30-09-2013 21:13:13 |
| 6 | Account | Account locked Inlab access issue, |
| | Management/provisioning | Please create user access for service account CED\CED-En |
| | | Case App in following servers |
| 7 | Shared Drive Access | Shared Drive Request for Access, |
| | | Access to FTP and Phoenix Shared Drive - Kevin Burns |
| 8 | Server build | VM Build request - assign to Windows Team ref Wilco |
| | | New server build for server: SERVERNAME |
| 9 | Printer management | New Zebra Printer Setup, |
| | (ex; create/remove, | Set Printer queues spooler setting to start printing after last |
| | clear map printer etc.) | page spooled, |
| | | Printer Creation Request |
| 10 | Decommission | SAMPLE CHANGE REQUEST00009914-Decommission |
| | Request | of Servers SERVERNAME and SERVERNAME, |
| | | Decommission of server “SERVERNAME” - SAMPLE |
| | | CHANGE REQUEST00013305 |
| 11 | Grant/Remove Access | Access on g_MapClientDrives, |
| | Issue/Request | access to \\ SERVERNAME\AduanaSoft and \\ |
| | | SERVERNAME\AduanaSoft |
| 12 | Create/delete share | CREATE A SHARED FOLDER, |
| | folder | Need to setup a shared folder on TR.IZM.GZMIR NAS in |
| | | Mixed Mode (Unix + Windows) |
| 13 | Tree size report | Please send the Tree size report for SERVERNAME and |
| | | SERVERNAME, |
| | | Execute Tree Report and analysis request |
| 14 | Battery Issue | Battery 0 Dell on SVRW-SG-XYZZZ is Critical, |
| | | Accelerator Board Battery 2 on SVRW-NL-SERVERNAME |
| | | is Critical |
| 15 | Software | Execute Install .net 2.0 framework on SERVERNAME, |
| | Install/uninstall | Format and reinstall OS on SharePoint Devserver_SAMPLE |
| | request | INCIDENT014XYZ |
| 16 | SNMP Agent issue | SERVERNAME SNMPAgent Not Responding 01-06-2013 |
| | | 05:35:5 |
| 17 | Replicate TNS entry | Replicate Global tns file in all dc's, |
| | | Replicate the Global TNS on all DC. \\ |
| | | SERVERNAME\CBS_Data01$\Oracle\00942_xyzdba2\Teamfolder\ |
| | | tns |
| 18 | FTP issue/request | FTP account on SERVERNAME, |
| | | FTP login for username from Teleflex - GHO-2013-1044 |
| 19 | Add/remove TNS | Kindly add TNS entry, |
| | Entry | update tns entries on tns.admin for new EASE |
| 20 | Remote desktop | B&D-Spain - Remote desktop access., |
| | access | New Request for Remote desktop access |
| 21 | IP Address | IP reservations, |
| | reservation | Need to create IP reservation (static-DHCP) for a DVR in the |
| | | YYZ station |
| 22 | Unable to access | Cannot access MOVEX, |
| | movex | Unable to access Movex, get a Citrix error |
| 23 | Restart spooler | Restart spooler on SERVERNAME 309 jobs in print |
| | | SERVERNAME, |
| | | Restart spooler and clear queue |
| 24 | Kill session/job | Please kill all active session for my ID - userid, |
| | | To kill any active sessions on Citrix for Account CCPI |
| | | Production SERVERNAME |
| 25 | Delete | Delete all jobs in queue, |
| | job/chain/module | please delete all jobs in the queue |
| 26 | VPN Wireless Access | WWIMS: WWIMS VPN Wireless Access Provisioning |
| | | Task. |
| 27 | Restart Application | SERVERNAME server needs to be restarted, applications |
| | | are not responding |
| 28 | Power Supply issue | Storage System Fault Tolerant Power Supply degraded, |
| | | Power sub-system degraded or failed |
| 29 | Change/modify | Change Ownership and Access for the |
| | ownership (ex; | (\\SERVERNAME\depts$) T:\ProcDoc & |
| | group/folder) | T:\Manufacturing_ProcessDoc, |
| | | Share folder owner change |
| 30 | Health check report | [Windows]-Server Online Status or Health Check |
| 31 | SOX review/audit | SOX AUDIT: List of users who have access to CITRIX |
| | | TOAD or Local TOAD |
| 32 | Disk failure | Minor-1232sr10-Disk (7 - None): The device |
| | | DeviceHarddisk2 has a bad block. |
| 33 | Password | FTP SERVER password reset & guidance on sending pdf |
| | Management (ex; | from archive to FTP folder, |
| | reset, expiry, | Please reset my account password |
| | troubleshooting etc.) | |
| 34 | NTFS delayed write | Delayed Write Lost |
| | loss | |
| 35 | Restart database | CKGP2 database restarted on Aug 20th at 22:17 C |
| 36 | Backup failure | [Windows]-Backup Failure or Partial or Hung |
| 37 | Connection failure | [Windows]-WinRM or Connection Failure Alert |
| 38 | Utilization Issue | SERVERNAME ~ ~ ~ CPU Utilization of SERVERNAME is |
| | (Alerts related to | high |
| | CPU, Memory, Disk, | |
| | Network etc.) | |

TABLE 2
Examples of low complexity activity in Active Directory

| Sl. No | Activity/Category/Tasks | Example of Ticket Summary |
|---|---|---|
| 1 | Account | Account disable issue |
| | Management/provisioning | |
| 2 | AD disabled for Lync | \|Lync Users\|AD Disabled or Enabled\| |
| 3 | Create/delete DNS record | Create a HOST A DNS record |
| 4 | Create/delete host | Create a new record for SERVERNAME |
| | record/name | |
| 5 | Create/delete share folder | Create/Modify/Delete File Share |
| 6 | Decommission Request | CR - SAMPLE CHANGE XXXXXXXX00009083 |
| | | Decommission SERVERNAME |
| 7 | DHCP Pool request | Clear DHCP pool for Malaysia subnet |
| 8 | DHCP reservation request | DHCP reservation required on EDC DHCP servers |
| 9 | DHCP Scope request | Add IP Address to DHCP scope for new HCL site in |
| | | Pune |
| 10 | Disable/enable screen | disable the screen saver/pc |
| | saver | telecamereDimafMonterotondo |
| 11 | Domain Controller Reboot | Scheduled Domain Controller Reboot |
| 12 | Enable/Disable computer | Enable computer in AD |
| | in AD | |
| 13 | Enable/Disable ID | Pierce, Michael D's ID enable request |
| 14 | Envision connectivity | enVision cannot connect to Windows Application |
| | issue | event log |
| 15 | Event log issue | Event log is full - The DNS Server log file is full. |
| 16 | Grant/remove Access | $ Client hold $ oursource access |
| | issue/request | |
| 17 | IP Address reservation | IP Address Reservation |
| 18 | Join PC to domain | Rejoining PC to the domain issue |
| 19 | Login issue | $Client Hold$ - - - cannot login to myapps |
| 20 | Mac Reservation | Mac Reservation |
| 21 | Password Management | Network password reset, |
| | (ex; reset, expiry, | DRA reset password |
| | troubleshooting etc.) | |
| 22 | Perform checklist of | Perform checklist on the logistics domain controller |
| | Domain Controller | |
| 23 | Printer management (ex; | New Printer IP Reservation - LHR Hounslow |
| | create/remove, clear map | |
| | printer etc.) | |
| 24 | Provide access to server | RE: Scan safe Website Exception Request |
| 25 | Provide/remove access | Request to create groups in AD to provide access on file |
| | | shares |
| 26 | Reboot Activity | A records to be modified for the SharePoint dev |
| | | environment SAMPLE INCIDENT01348XYZ |
| 27 | Remove server | Execute Need to remove server from AD group |
| 28 | Server build | New Build server - SERVERNAME |
| 29 | Shared Drive Access | Create Share Drive Access for 15CS Level 3 Multi- |
| | | Cilent |
| 30 | Space issue | Logical Disk Free Space is low - The disk D |
| 31 | Login issue | Unable to login to domain |
| 32 | Utilization Issue (Alerts | ALERT: CRITICAL: CPU Utilization of Node CL-NL- |
| | related to CPU, Memory, | SERVERNAME is now 93% |
| | Disk, Network etc.) | |

TABLE 3
Examples of low complexity activity inVMware

| Sl. No | Activity/Category/Tasks | Example of Ticket Summary |
|---|---|---|
| 1 | Battery Issue | SERVERNAME_Array Controller Battery Failure, |
| | | SERVERNAME::HPSIMInt-263: The battery |
| | | associated with Intelligent Drive Array Accelerator |
| | | Write C |
| 2 | Bring server down | Execute Please shutdown SERVERNAME tomorrow |
| | | Satutday Feb 23rd 7:00am CET |
| 3 | ESX Host Process stopped | SERVERNAME -nworks Collector: ESX Host Process |
| | | ‘bdflush’ has stopped |
| 4 | Execute backup | Execute SERVERNAME servers backups |
| 5 | vCenter SNMP Agent | SERVERNAME --vCenter SNMP Agent vpxd Alarm |
| | Alarm | for target SERVERNAME |
| 6 | Utilization Issue (Alerts | ESX Host Available Memory has dropped below |
| | related to CPU, Memory, | threshold, |
| | Disk, Network etc.) | HPSIMInt-748: The Advanced Memory Protection |
| | | subsystem |

TABLE 4
Examples of low complexity activity inSCCM

| Sl. No | Activity/Category/Tasks | Example of Ticket Summary |
|---|---|---|
| 1 | Account | AdLogRev-account locked out-EU/userid |
| | Management/provisioning | |
| 2 | Envision connectivity | Execute enVision - Delete non SOX device: |
| | issue | SERVERNAME |
| 3 | Configure SCCM to push | Configure SCCM to push package |
| | package | |
| 4 | Execute SCCM package | Execute C0100145 - Document Desktop Client v53 |
| | | SP4, |
| | | Execute SCCM package |
| 5 | Add machines in SCCM | Execute ISM SERVICE REQUEST: Add machines in |
| | pilot | the PILOT Collection |
| 6 | Download package to | Execute Please download the package XYZAB to |
| | SCCM server | SCCM server |
| 7 | Remove SCCM records | Execute please REMOVE SCCM records |
| 8 | Replicate packages to | Execute Replicate those Packages to the SCCM Server |
| | other SCCM server | in Stockholm |
| 9 | Remove workstation from | Remove workstation from SCCM database, |
| | SCCM | Execute Please delete the machines from our SCCM |
| | | server console |
| 10 | Space issue | Logical Disk Free Space is low - The disk E |

TABLE 5
Examples of low complexity activity in Citrix

| Sl. No | Activity/Category/Tasks | Example of Ticket Summary |
|---|---|---|
| 1 | Account | Create Account/Access (Add/Remove Access) for |
| | Management/provisioning | Username's, |
| | | Modify Account/Access (Add/Remove Access) for |
| | | Username's |
| 2 | Application issue | Cannot launch Citrix Application |
| 3 | Cannot launch | Cannot launch MWMS - Discrete from Citrix |
| | MWMS(Mobile Work | |
| | Management System) | |
| 4 | Citrix access issue/ | Citrix Access for FileZilla Client, |
| | request | Execute Accessing a published app on Citrix server, |
| | | New application request for Citrix access- 21 AUG |
| 5 | Printer management (ex; | Printer request, |
| | create/remove, clear map | Map the network printer \\ |
| | printer etc.) | SERVERNAME/xyzabcd420004 |
| 6 | Grant/remove Access | Access on Transnet test, |
| | issue/request | Access to Citrix (roaming) profile, |
| | | XYZ access via Citrix, |
| | | Grant access at MWMS Matrix to user Araujomarc, |
| | | Grant access to user Caamanoa (Alejandra Caamano) |
| | | on ABCD-2009 citrix icon |
| 7 | Login issue | Cannot login to XYZ |
| | | Whenever I login to the Citrix server SERVERNAME, |
| | | a Citrix plug-in message appears |
| 8 | Add/De-active Citrix icon | add a citrix icon named LXOneNorpac for network id |
| | | as xiangj, |
| | | can you please add the K-Time Icon onto my citrix |
| | | profile, |
| | | Deactivation of Citrix icons on 31 October |
| 9 | Citrix Session Purge | Citrix Session Purge Request |
| | Request | |
| 10 | Add new users to Citrix | Execute Request add new users to Citrix |
| 11 | Login issue | not able to log on to xyz production |
| 12 | Password Management | Password Reset for Username, |
| | (ex; reset, expiry, | Transnet password reset |
| | troubleshooting etc. | |
| 13 | Print spooler | Print spooler restart |
| 14 | Printer management ex; | adding a printer to my pc, |
| | create/remove, clear map | printer to be setup, |
| | printer etc.) | Printer Access |
| 15 | Shared Drive Access | Shared Drive Request PENDING for approval |
| 16 | Space issue | Acc to SW tool XXXXYY\ is 93%, |
| | | As per solarwinds report the server SERVERNAME |
| | | TX11-W:\ is 92%, |
| | | Logical Disk Free Space is low - The disk C |
| 17 | Transnet issue | Transnet application issue, |
| | | TransNet issue |
| 18 | Login issue | User is not able to login on CITRIX keep says the |
| | | access is denied |
| 19 | Utilization Issue (Alerts | : ALERT: WARNING: Node SERVERNAME-C:\ |
| | related to CPU, Memory, | Label:SYSTEM 2c0c2ca8 is now 90%, |
| | Disk, Network etc.) | As per SOLARWINDS repot Node SERVERNAME- |
| | | C:\ Label: 804accdc is now 91% |

TABLE 6
Examples of low complexity activity in Linux

| Sl. No | Activity/Category/Tasks | Example of Ticket Summary |
|---|---|---|
| 1 | Afrax request | Execute AFRAX requests |
| 2 | Grant/remove Access | Security:badsu |
| | issue/request | |
| 3 | Log message | /var/log/messages hda ide-device didn't answer for |
| | | interru, |
| | | System configuration file /etc/syslog-ng/syslog- |
| | | ng.conf.in was not found |
| 4 | Password Management | Execute Set OS user ID sdb to non-expiry, |
| | (ex; reset, expiry, | Reset password |
| | troubleshooting etc.) | |
| 5 | Provide access to server | Execute root access |
| 6 | Space issue | Disk Bottleneck probability |
| 7 | System log analysis | syslog:/sbin/syslogd, |
| | | System configuration file /etc/syslog-ng/syslog- |
| | | ng.conf.in was not found |
| 8 | Utilization Issue (Alerts | CPU load, bottleneck situation, current value: 100.00%, |
| | related to CPU, Memory, | Memory load, bottleneck situation, current value: |
| | Disk, Network etc.) | 99.27% |

TABLE 7
Examples of low complexity activity in UNIX

| Sl. No | Activity/Category/Tasks | Example of Ticket Summary |
|---|---|---|
| 1 | Utilization Issue (Alerts | SERVERNAME File System High Utilization 06-07- |
| | related to CPU, Memory, | 2013 02:36:33, |
| | Disk, Network etc.) | /var file system Increased to 85.01% |
| 2 | Grant/remove Access | Access required on /var/lib/tomcat_uat/work, |
| | issue/request | Request For access - XYZA QA team |
| 3 | Password Management | Solaris root Passwd Expiration, |
| | (ex; reset, expiry, | “userid” user password expired on SERVERNAME, |
| | troubleshooting etc.) | change password for oaobia on SERVERNAME |
| 4 | Device down | IP Address Interface Down 26-09-2013 12:23:43, |
| | | IP Address Host Down 22-10-2013 17:40:47 |
| 5 | Space issue | As per solarwindows report, the server SERVERNAME -- |
| | | /local/home02 is 94%, |
| | | FW: LISA: VAR volume on server SERVERNAME is |
| | | nearly full |
| 6 | Account | Create Account/Access (New User Request) for Barlow, |
| | Management/provisioning | Mark, |
| | | Modify Account/Access (Add/Remove Access) for |
| | | Miller, Josie, |
| | | Create account on servers. |
| 7 | Information request | Logging information required for ftp account userid, |
| | | Need information for person login to server |
| | | SERVERNAME |
| 8 | Printer management(ex; | create new Unix print queue, |
| | create/remove, clear map | Install Printer: on SERVERNAME |
| | printer etc.) | |
| 9 | SNMP Agent issue | IP Address SNMPAgent Not Responding 22-10-2013 |
| | | 22:52:09 |
| 10 | Appworx/Patrol | [Unix]-Patrol Agent Down Or Unreachable, |
| | Agent/master Down | SERVERNAME ~ ~ ~ PATROL_AGENT port is not |
| | | responding on SERVERNAME |
| 11 | Add/remove server in | Please add server at networker, |
| | application/database/monitoring | To Add server in BPPM: SERVERNAME, |
| | (ex; networker, | Please add server in password database and update server |
| | BPPM, password | lease tracker, |
| | database, SMART, | Please add the servers in EMC SMART console, |
| | server lease tracker) | Please remove server from SMARTS monitoring |
| | | SERVERNAME |
| 12 | Backup Restore test | Backup Restore test required for all DBs in IAH DC |
| 13 | Blade failure | 3 blades not responding on Huddersfield Linux grid after |
| | | restart |
| 14 | Change/modify | Change owner and permissions of directory, |
| | ownership | Change owner of /s01 to 775 with abcdef:dba in |
| | | djjajhahahj |
| 15 | Create/delete share | Create a share on server SERVERNAME |
| | folder | |
| 16 | Decommission Request | As CM#SAMPLE CHANGE REQUEST000000084054 |
| | | Server SERVERNAME (local zone) has been |
| | | decommissioned, |
| | | Decommission server SERVERNAME |
| 17 | Execute script | Execution of root.sh scrips |
| 18 | FP access issue | Cannot access the ftp server both dev and prod, |
| | | FTP access for Matrix XYZ - ABCD on SERVERNAME |
| 19 | Ftp connectivity issue | unable connect to tip resource |
| 20 | FTP issue/request | Expedient server SERVERNAME needs to connect to |
| | | abcde.nhiuuhhg.com, |
| | | FM FTP Payroll - not picked up |
| 21 | FTP report | Nike FTP report |
| 22 | Kill process | Kill runaway processes on SERVERNAME, |
| | | Please kill Apache process which are hung on |
| | | SERVERNAME |
| 23 | License Manager down | 3 License managers down. Please restart, |
| | | Flowmaster license manager is down on |
| | | SERVERNAME. Please restart |
| 24 | Log investigation | [Unix]-Log Investigation |
| 25 | Login issue | Cannot login SERVERNAME, |
| | | Facing Issue with UNIX. Not able to see Login Screen |
| 26 | Migration issue/request | Migrate servers, |
| | | Migration of ORXXX DB in UK DC |
| 27 | Node/connection/partition/ | Volume/home/abdcef on Node SVRU-US-IAH- |
| | volume Down | SERVERNAME is Down |
| 28 | OEM Agent deployment | OEM agent deployment on server: SERVERNAME |
| 29 | Power Outage | Dec 14 - please power down SERVERNAME |
| 30 | Process restart | Process Restart failed |
| 31 | Provide access to server | Please remove CRTI Unix home drive and account, |
| | | Request No: AXXXX-99FMHP |
| 32 | Reboot Activity | /matrix is unmounted after server SERVERNAME got |
| | | rebooted, |
| | | BMS CCPI production server reboot activity |
| 33 | Remove files | CRITICAL: Please remove the files from NDH, |
| | | Please remove the files from the mentioned path |
| 34 | Restart Application | Please stop and restart the Flexnet Manager application. |
| | | See NOTES |
| 35 | Restart database | CTG Linux grid: restart abc:fsda_db on multiple nodes |
| 36 | Restart services | backup failure: SERVERNAME, please restart networker |
| | | services, see notes, |
| | | Please restart Bladelogic services on server - |
| | | SERVERNAME |
| 37 | System audit issue | System Failed Audit Report |
| 38 | Tree size report | snmp Process Restart failed |
| 39 | VNC issue | Restart VNC session in SERVERNAME & |
| | | SERVERNAME |

TABLE 8
Examples of low complexity activity in AS 400

| Sl. No | Activity/Category/Tasks | Example of Ticket Summary |
|---|---|---|
| 1 | Account | Create Account/Access (New User Request) for |
| | Management/provisioning | Username, |
| | | Terminate Account/Access for Username |
| 2 | Audit report | Audit report for OFS |
| 3 | Create a MOFS Report | Create a MOFS Report |
| 4 | Printer management(ex; | Create Printer Group, |
| | create/remove, clear map | PKMS: Add printer, |
| | printer etc.) | Change Printer IP |
| 5 | Email Trigger Notification | Email Trigger Notification Not Received, |
| | | No email trigger notification received from OneID |
| | | application to OneID Service Center |
| 6 | Grant/remove Access | List of users who have STRSQL access in PKMS |
| | issue/request | production (SERVERNAME) box for all contracts |
| 7 | Health check report | Create a health check report, |
| | | Need to prepare the Health Check Report |
| 8 | Login issue | MOFS login issue |
| 9 | Password Management | AS/400 password reset, |
| | (ex; reset, expiry, | Password Reset for userid |
| | troubleshooting etc.) | |
| 10 | Replication report | Create a replication report |

TABLE 9
Examples of low complexity activity in Database

| SI. No | Activity/Category/Tasks | Example of Ticket Summary |
|---|---|---|
| 1 | Space issue | /orabackup mount point is not visible on EDW Stage |
| | | Node 1, |
| | | Please add space on the db XYZABC, |
| | | BASELINE SPACE RECLAIM_pkdab |
| 2 | Execute script | [Database]-SQL Script Execution-v1.0, |
| | | Modify the existing AWR script for Maximo PROD |
| | | DB to get weekly AWR report for DB: ABCDE7 |
| 3 | Grant/remove Access | Give access on following views, |
| | issue/request | Kindly Provide the access, |
| | | Need access on sys.link$ on maxmt7 |
| 4 | Utilization Issue (Alerts | IP Address File System High Utilization 05-06-2013 |
| | related to CPU, Memory, | 18:19:47, |
| | Disk, Network etc.) | File system abc is 95.006000% full on |
| | | SERVERNAME - IP Address Threshold 95% < |
| | | 95.006000% < 100% |
| 5 | Account | Unlock user account Lrs for database xyza, |
| | Management/provisioning | Create my account on “xxx” and “yyy”, |
| | | Please create the database user account on mentioned |
| | | DBs |
| 6 | Add/remove TNS Entry | Add below tns entry in global tnsnames.ora file, |
| | | Add TNS Entry in Global TNS file |
| 7 | Blackberry issue | Blackberry is not able to connect to SQL server and |
| | | giving error at initialization |
| 8 | Bring appworx | Bring SERVERNAME down for VPLEX move, |
| | agent/database/server | Please bring the DB (ABCD) down on the Server |
| | down | SERVERNAME |
| 9 | Change memory | Please change the memory parameter |
| | parameter | |
| 10 | Change parameter | Need to change parameters on GDPP1 |
| 11 | Cold backup | Cold backup of ABCXYZ database, |
| | | PGBU Production DB cold backup |
| 12 | Cold backup Problems | Cold backup Problems SERVERNAME, |
| | | Critical Cold backup Problems SERVERNAME |
| 13 | Create login | Please create specified login id's in 11g OEM |
| 14 | Create Table space | Create new table spaces in EDW Dev, |
| | | Kindly create table space |
| 15 | Database bounce | Bounce below database, |
| | | SERVERNAME_PRD1 needs to be bounced at |
| | | 12PM IST today |
| 16 | Decommission Request | On server SERVERNAME please drop dbsid rmepx1 |
| | | and recreate the same, |
| | | please decommission databases on server |
| 17 | Drop table space | Drop the table spaces |
| 18 | Enable CC Monitoring | Add entry in CC Monitoring: |
| | | BFCUPG_SERVERNAME, |
| | | Enable CC Monitoring |
| 19 | Export Problem | Export problem on SERVERNAME |
| 20 | Export_mon Report | Export_mon Report: Please investigate following |
| | | export issues |
| 21 | Failed Email Submit | Failed Email Submit |
| 22 | FTP issue/request | need to trace session sid = 2, serial# = 59593 on |
| | | database - abcxyz |
| 23 | Global Parameter alert | [Database]-Alarm of Global Parameter triggered- |
| | | v1.0.pdf |
| 24 | Hot Backup Problem | Hot Backup Problem: SERVERNAME |
| | | SERVERNAME08 |
| 25 | Hotbackup_mon Report | Hotbackup_mon Report: Please investigate following |
| | | hotbackup issues |
| 26 | Information request | Need information on the Back up timings |
| 27 | Kill session/job | Need to kill a session on SERVERNAME |
| 28 | Password Management | “Password expired” for some accounts in userid, |
| | (ex; reset, expiry, | Make database passwords permanent, |
| | troubleshooting etc.) | kindly reset password of userid user on database: |
| | | SERVERNAME_prd1.world |
| 29 | Provide access to server | Request No: XXXX-986JHV |
| 30 | Reboot Activity | As per proactive maintenance for EDW month end |
| | | planning, please reboot below db servers, |
| | | Please reboot XYZ dev and staging db. |
| 31 | Refresh Database | Please provide crontab refresh MV details on ABCD0 |
| 32 | Remove entry from | Please remove entry from Global tnsnames.ora file |
| | Global tnsnames | |
| 33 | Restart database | Need to restart the HA Stage Database instance, |
| | | Please restart sftp1 database at 11 45 PM EST today |
| 34 | Server level blackout | Please put server level blackout on SERVERNAME, |
| | | Blackout on SERVERNAME |
| 35 | Table space issue | Add 15 Gb space in DFL_DATA table space on |
| | | ABCD10, |
| | | Add free space in TEMP table space on db - |
| | | isssdmp1_SERVERNAME.WORLD |

TABLE 10
Examples of low complexity activity inOracle

| SI. No | Activity/Category/Tasks | Example of Ticket Summary |
|---|---|---|
| 1 | Account | Create Account/Access (New User Request) for |
| | Management/provisioning | Username, |
| | | Modify Account/Access (Add/Remove Access) for |
| | | Username, |
| | | Terminate Account/Access for Username |
| 2 | Audit request | Audit Request - Oct13 Oracle reports via OCS |
| 3 | Grant/remove Access | Access to ABCXYZ DB, |
| | issue/request | Database Access for Username, |
| | | RDP and DBA access |
| 4 | Password Management (ex; | Forgot User ID/password, |
| | reset, expiry, | Password Expired SERVERNAME, |
| | troubleshooting etc.) | Oracle Password Reset |
| 5 | Reboot Activity | Need to restart PTAU (UAT) & PTAD (Production) |
| | | database to enable archive log mode |
| 6 | Release session | Release session from IP Address |
| 7 | Restart agent | Restarting the oem agent for ckds1 |
| 8 | Restart database | ABCXYZ database restart |
| 9 | Restart services | Restart ABCD listener services |
| 10 | Software release | Software release to ABC0611P |
| 11 | Utilization Issue (Alerts | ALERT: WARNING: Node SERVERNAME -D:\ |
| | related to CPU, Memory, | Label: Data aca3845b is now 90% |
| | Disk, Network etc.) | |

TABLE 11
Examples of low complexity activity in SQL

| SI. No | Activity/Category/Tasks | Example of Ticket Summary |
|---|---|---|
| 1 | Database backup request | DB Backup Request |
| | | UAT DB backup file used for the web visibility |
| | | application is required |
| 2 | Database Down | Alert: Status of SVRW-US-IAH- SERVERNAME- |
| | | G:\ 4a5dfe0e is Down |
| 3 | Database Mirroring Error | Database Mirroring Error- SERVERNAME \WMS |
| 4 | Deployment issue | Deploy and schedule DTS package on |
| | | SERVERNAME server |
| 5 | Deployment request | RE: Deployment for CP#GHO-2013-10220, |
| | | SCA database deployment |
| 6 | Execute script | Execute SQL Script, |
| | | Please run archive scripts |
| 7 | Grant/remove Access | Can you please give me the READ access on remedy |
| | issue/request | production database and test database, |
| | | RE: Request to Create User access on |
| | | SERVERNAME, SERVERNAME2 |
| 8 | Log file full | SQLdm Alert (Warning) - Log files are 75.43% full |
| | | for database [tempdb] on SERVERNAME \MATRIX |
| 9 | Multiple alerts | Multiple SQL ABCXYZ alerts |
| 10 | OS memory alert | SQLdm Alert (Critical) - OS memory used is 95.10% |
| | | on SERVERNAME \SUPPORT |
| 11 | Refresh Database | Refresh database KPI UAT & Staging, |
| | | Refresh the XYZ UAT database |
| 12 | Remedy performance issue | Remedy performance issue |
| 13 | Session blocked alert | (Critical) - Session 508 blocking for 563 seconds, |
| | | 1/9/2014 5:04:35 AM. on SQL54\INTEGRATION, |
| | | Blocked sessions on ABC54\INTEGRATION, |
| | | Multiple blocking session alerts on |
| | | ABC54\INTEGRATION |
| 14 | Space issue | : ALERT: WARNING: Node CL-US-IAH- |
| | | SERVERNAME -D:\ Label: Cabc543626 is now 92% |
| 15 | SQL Agent job alert | SQLdm Alert (Critical) - SQL Agent job [ETL - GIT |
| | | All Regions LastStatus] completed with a status of |
| 16 | Transaction Log alert | DB Maintenance Plan ′Backup & Transaction Log |
| | | Backups″ completed on \\ABCSQL001, |
| | | SQL Server Job System: ′Transaction Log Backup |
| | | Job for DB Maintenance Plan ′Backup & Transaction |
| | | Log |
| 17 | TRANSACTIONS OPEN | TRANSACTIONS OPEN OVER 1 HOURS, |
| | DURATION | TRANSACTIONS OPEN OVER 1 HOURS --- SPID = |
| | | 106 |
| 18 | Utilization Issue (Alerts | ALERT: CRITICAL: Node SVRW-NL- |
| | related to CPU, Memory, | SERVERNAME -D:\Label: DATA ae417078 is now |
| | Disk, Network etc.) | 97% |

TABLE 12
Examples of low complexity activity in Exchange

| SI. No | Activity/Category/Tasks | Example of Ticket Summary |
|---|---|---|
| 1 | Account | Account Always locked. Need log for root cause, |
| | Management/provisioning | BR/RS/XXXXX - SW - AD - Network Account |
| | | locking constantly, |
| | | Execute deactivate NT account |
| 2 | Active Sync high hits report | Active Sync High Hit Report \|\| 9th Aug. 2013 |
| 3 | ActiveSync Device/User | Active Sync users list, |
| | Statistics Report | ActiveSync Device Statistics Report @ Last 24 |
| | | hours |
| 4 | Blackberry issue | Blackberry activation code, |
| | | blackberry issue, |
| | | Calendar appointments 1 hour out when created on |
| | | Blackberry |
| 5 | Blackberry server reboot | Blackberry Server reboot activity, |
| | | FW: Please Ignore the reboot alert for 4 blackberry |
| | | servers |
| 6 | Change/modify ownership | Execute change of owner of the D1s |
| 7 | Create/delete mailbox | Execute delete ACCOUNT NAME email address |
| | | from global address list, |
| | | Execute Create a Mailbox, |
| | | Execute Delete from GAL Obsolete email address |
| 8 | Create/delete share folder | Restore subfolder from Shared Email box |
| 9 | Database server error | A message transfer agent (MTA) database server |
| | | error was encountered |
| 10 | Decommission Request | FW: Exchange Remediation - POP3 Mailbox Server |
| | | Decommissioning - DEADLINE DATE 19th |
| | | Nov. 2013 |
| 11 | Event log issue | One or more Objects properties are pointing to |
| | | Active Directory deleted objects. See event log |
| 12 | Exchange Daily Check List | \| Daily Exchange Checklist \| 15th Dec. 2013 \| |
| 13 | Exchange Service Monitor | Exchange Service Monitor Report - 2013 Sep. 15 |
| | Report | |
| 14 | Frequent Lockout | Frequent Account Lockout |
| 15 | Grant/remove Access | Execute Access to Archive from a user, |
| | issue/request | Execute Access to PVG inbox, |
| | | Execute Full access to DL --SAMPLE |
| | | INCIDENT000010811XXX |
| 16 | Group membership update | Execute Add new GSD agent to the ITSUS GSD |
| | | group for full permissions to the GSD mailbox |
| 17 | IIS Reset | IIS Reset |
| 18 | Increase mailbox send limit | Execute Please increase the Send To limits on a |
| | | mailbox |
| 19 | Information on number of | Need number of active mailboxes, |
| | active mailbox | Total Active Mailbox's in ACCOUNTNAME 2 Oct. |
| | | 2013 |
| 20 | Mail Queue Report | FW: Mail Queue Report for Aug. 20, 2013 |
| 21 | Mailbox Issue | Issue with mailbox, |
| | | Ref: SAMPLE INCIDENT01393XXX Room |
| | | Mailbox not working |
| 22 | Mailbox permission | Access group.rrm mailbox, |
| | | Execute grant full mailbox rights to users - |
| | | USERID1, USERID2, |
| | | User cannot see the rights of the mailbox |
| 23 | Mailbox quota Sample | Increase Mailbox Quota |
| | Increase | |
| 24 | Mailbox size issue | Angie Ng called to Increase the mail box size for the |
| | | user Elaine Low, |
| | | Execute Increase MAILBOX SIZE, |
| | | Exchange mailbox has 250 mb after migration, he |
| | | had 500 mb |
| 25 | Move Messages | Move messages from Poison Queue |
| 26 | Provide logs | SERVERNAME WARNING: Exchange logs too |
| | | large |
| 27 | Reboot Activity | \| Blackberry Server reboot activity \| |
| 28 | Remove from DL, GAL | Execute Add or Remove on DL, |
| | | Execute Remove Conference Room's from GAL, |
| | | Execute remove DL from GAL |
| 29 | Restrict sending to a certain | Possibility to restrict sending to a certain mailbox |
| | mailbox | |
| 30 | Space issue | Logical Disk Free Space is low - The disk P |
| 31 | Suspected spam | [SUSPECTED SPAM] PLEASE REPLY ASAP, |
| | | Outlook “Block Sender” Spam email filter no longer |
| | | works |
| 32 | Login issue | User unable to login into mailbox |
| 33 | Unable to send mail to/from | Client can't send mail to my mailbox, |
| | shared mailbox | Execute Cannot send from shared mailbox |
| 34 | Update GAL | Execute Update GAL |
| 35 | Utilization Issue (Alerts | A memory allocation failure affected a database |
| | related to CPU, Memory, | copy on the local server, |
| | Disk, Network etc.) | ALERT: WARNING: Node SVRW-NL- |
| | | SERVERNAME -D:\ Label: 7c9099180 is now 90% |

TABLE 13
Examples of low complexity activity in Lync

| SI. No | Activity/Category/Tasks | Example of Ticket Summary |
|---|---|---|
| 1 | Account | Modify Account/Access (Add/Remove Access) for |
| | Management/provisioning | Atkinson, Marc, |
| | | Terminate Account/Access for Dogra, Meenal |
| 2 | Grant/remove Access | Lync Dial in access revoked, |
| | issue/request | Modify/Access (Add/Remove AccAccountess) Dial |
| | | Lync |
| 3 | Iphone issue | LYNC mobile for iPhone is still not working correctly. |
| 4 | Lync Usage Reports | \| Lync Usage Reports \| August 2013 & September 2013 \| |
| 5 | Slowness issue | Lync conference signal is not good (N/w slow) |

TABLE 14
Examples of low complexity activity in Mobility

| SI. No | Activity/Category/Tasks | Example of Ticket Summary |
|---|---|---|
| 1 | Account | Execute Create new Airwatch and xyz accounts for new |
| | Management/provisioning | GSD agents, |
| | | Execute Remove users from AirWatch |
| 2 | Blackberry issue | Blackberry activation Code, |
| | | Blackberry Issue |
| 3 | Grant/remove Access | Execute Access for xyz and AIRWATCH, |
| | issue/request | Execute Mobility Tools Access Request |
| 4 | Software Install/uninstall | Execute uninstall Office communicator, |
| | request | MxEngage installation issue |
| 5 | iPAD issue | iPAD issue/registration |
| 6 | Iphone issue | Assistance Setting Up AirWatch on iPhone, |
| | | Iphone Issue, |
| | | Iphone setup |
| 7 | Password Management | Airwatch password reset |
| | (ex; reset, expiry, | |
| | troubleshooting etc.) | |

TABLE 15
Examples of low complexity activity in Networks

| SI. No | Activity/Category/Tasks | Example of Ticket Summary |
|---|---|---|
| 1 | Access port request | I need port 16 on IP ADDRESS put on v-lan 511, |
| | | SERVERNAME FastEthernet0/37 Please turn on this |
| | | port |
| 2 | Bandwidth/Utilization | 31 Day Utilization Report, |
| | Report request | Bandwidth Utilization report, |
| | | Please provide Network utilization reports for |
| | | SERVERNAME server |
| 3 | Blade failure | Major-X.ABCXYZ.tele.fi-BLADE STATUS |
| | | UNKNOWN |
| 4 | Change port | Change port setting on Cisco Switch IP ADDRESS, |
| | | Change ports to vlan 100 on switches of ACCOUNT |
| | | NAME Boom |
| 5 | Decommission Request | 5N Enclosures to be Decommissioned, |
| | | Decommission of SERVERNAME |
| 6 | Device down | IP ADDRESS Switch Down 17-06-2013 20:16:43, |
| | | LAN Group: Interface Down- Gi0/1 hosted on node |
| | | ABCXYZ_f11-1_north_america with IP ADDRESS |
| 7 | Enable port | SERVERNAME needs port enabled, |
| | | Please enable port ABCXYZ Fa1/0/4 |
| 8 | Grant/remove Access | Access to customers website, |
| | issue/request | Internet access on guest network |
| 9 | LAN port issue | LAN port enable, |
| | | LAN port issue |
| 10 | LINK-PORT alert | LINK-IF-IP ADDRESS/128<->IF-abcdyh/14 Network |
| | | Connection Down 17 Jun. 2013, |
| | | LINK-IF-IP ADDRESS/955<->PORT- |
| | | SERVERNAME/3 Cable Down 12 Jun. 2013 |
| 11 | Migration issue/request | GM Mainframe Migration to new GM Enterprise Data |
| | | Center - Oct 19/20, |
| | | Please create a Sr for Blade Migration On |
| | | SERVERNAME |
| 12 | Node/connection/partition/ | LAN Group: Node Down- acBGYAAA_europe with IP |
| | volume Down | ADDRESS is down at Sun Jul 14 04:42:31 EDT 2013 |
| | | a, |
| | | LAN Group: Node or Connection Down- |
| | | BRAZIL_AP02 with IP ADDRESS at Thu Oct 31 |
| | | 10:06:24 EDT 2013, |
| | | Partition-105/AM-PM Partition Down 26-06-2013 |
| | | 07:59:34 |
| 13 | Port identification | Please identify the port of the SERVERNAME |
| 14 | Port Verification - Server | Port Verification - Server Decommission |
| | | SERVERNAME |
| 15 | Power Outage | Planned power outage, |
| | | Power outage at EBU/Seoul office, |
| | | Power outage at Holset location on 17th Aug. 2013 at |
| | | 12:00pm UK time |
| 16 | Power Supply issue | IP ADDRESS Power Supply StateNotNormal 22-11- |
| | | 2013 18:46:25 |
| 17 | Problem status report | Problem status report, 2440622, DN41506, KIEV |
| 18 | Provide access to server | Approval ABCD-9BWH7S, |
| | | Modified Security exception XYZ-8XLHVY Reference |
| | | approved security exception for details. |
| 19 | RDP issue | RDP issue |
| 20 | Remote site unreachable | LAN Group: Remote site containing XXX21-Switch-1 |
| | | with IP ADDRESS is unreachable at Sat Nov 23 |
| 21 | RTR and SW Down | Multiple RTR and SW Down Alerts |
| 22 | SNMP Agent issue | IP ADDRESS SNMPAgent Not Responding 17-06- |
| | | 2013 22:24:29 |
| 23 | Switch configuration | LAN Group: Need help with switch config |
| | request | |
| 24 | Uptime report | Need uptime report of 3 Wireless APs at DTC, Pune. |
| 25 | Utilization Issue (Alerts | : ALERT: LINK UTILIZATION: RTR-ap0080-r1- |
| | related to CPU, Memory, | ABCDEF-a091-mpls 10.69.152.2 |
| | Disk, Network etc.) | |
| 26 | VLAN inaccessible Site | RE: VLAN 600 inaccessible Site ABCZYZ. |
| 27 | Wireless Access point | AP problems with Crosspoint HQ location |
| | issue | |

TABLE 16
Examples of low complexity activity in Backup

| SI. No | Activity/Category/Tasks | Example of Ticket Summary |
|---|---|---|
| 1 | Add servers to backup | Add Server to Backup Rotation, |
| | | Execute Add servers to backup schedule |
| 2 | Backup failure | Backup Failures - 10 Sep. 2013 EDC |
| 3 | Backup report | [Backup]-NA Backup Report, |
| | | Execute Net Backup Vaulting Report - Library Content - |
| | | SERVERNAME - Report is incorrect |
| 4 | Backup Restore test | Backup Restore required for all DBs in IAH DC |
| 5 | Decommission Request | CR - SAMPLE CHANGE XYYYYZZZZ00009083 |
| | | Decommission SERVERNAME, |
| | | SAMPLE CHANGE REQUEST00010932 --- |
| | | Decommission of server NTserver6 |
| 6 | Execute backup | Execute Backup Removal Request, |
| | | Execute New backup request |
| 7 | Health check report | SERVERNAME: Critical 11/04/2013 12:30 OMNITRIG |
| | | HealthCheckFailed “[138:709] Health check message: |
| | | “omnisv -status” failed.”, |
| | | [Backup]-Netbackup - Health check |
| 8 | Software Install/uninstall | Backup agent need to install |
| | request | |
| 9 | Migration issue/request | SERVERNAME Migration Activity, |
| | | Storage for ABCDEF DB and file system migration |
| 10 | Recall Backup Tapes | AIX Backup Tape - - Nov. 1, 2013 |
| 11 | Restore Test | [Backup]-Test Restore-v1.0, |
| | | Bi-weekly EDC restore test |
| 12 | Space issue | As per SW top 10 report SVRW-UK- SERVERNAME - |
| | | C:\ is 90% full, |
| | | Logical Disk Free Space is low - The disk D/Disk G/Disk |
| | | Q/Disk P |
| 13 | Utilization Issue (Alerts | Critical- SERVERNAME -Average (2 samples) physical |
| | related to CPU, Memory, | memory usage is now 92%, which is above the error |
| | Disk, Network etc.) | threshold (90%) |

TABLE 17
Examples of low complexity activity in Storage

| SI. No | Activity/Category/Tasks | Example of Ticket Summary |
|---|---|---|
| 1 | Disk failure | [Storage]-Disk failure or drive replacement, |
| | | [Storage]-Disk or Shelf Count Mismatch or Disk is |
| | | faulted |
| 2 | Drive Array alert | L1XXX543: An alarm has occurred on HP P6000 Array |
| | | System: ABC145THS WWN: 5001-4380-013C-05C0 |
| 3 | Health check report | [Storage]-NA health Check |
| 4 | Space issue | Critical-xxyyzznn-Srv (2013 - None): The C: disk is at or |
| | | near capacity. You may need to delete some files. |

TABLE 18
Examples of low complexity activity inRemedy

| SI. No | Activity/Category/Tasks | Example of Ticket Summary |
|---|---|---|
| 1 | Account | [Remedy]-Remedy Account |
| | Management/provisioning | Creation/Deletion (HCL User) |
| 2 | Login issue | [Remedy]-Remedy Login Failure |

TABLE 19
Examples of low complexity activity in Appworx

| SI. No | Activity/Category/Tasks | Example of Ticket Summary |
|---|---|---|
| 1 | Account | AAC Request No: ABCD-ABC651 for MaevaBourhis, |
| | Management/provisioning | Account creation for user-ABCD in Appworx, |
| | | Please setup user in appworx master |
| 2 | Add entry | Please add below entry in |
| | | /usr/users/aw_cic_ABCD/exec/authoriz.lis |
| 3 | Agent stopped | agent ABCYD02 stopped for the activity, |
| | | Appworx agents need to be stopped in BOLT OVM |
| | | Servers |
| 4 | Appworx access | Appworx access, |
| | | APPWORX STG ACCESS |
| 5 | Appworx agent issue | Appworx agent ABCXY15 issue (SERVERNAME |
| | | master), |
| | | Appworx agent is not working. Please reset. FPEDI |
| | | Appworx. |
| 6 | Appworx change | Appworx Change in SERVERNAME, |
| | | SERVERNAME appworx change request |
| 7 | Appworx job not running | All jobs in SERVERNAME is in Hung state. Please |
| | | check ASAP, |
| | | Appworx chain jobs are not running, |
| | | CTT IND: appworx job failed in SERVERNAME |
| 8 | Appworx Migration | Appworx: Migration of chain with components and |
| | | conditions, |
| | | CTT Enhancement - Appworx Migration- |
| | | SERVERNAME - CR4671 - HSTPROD, |
| | | Migration of Appworx chains from Stage to Prod |
| 9 | Appworx request | Appworx request.-Please to change the language to my |
| | | applications manager in proxy, |
| | | SERVERNAME appworx request |
| 10 | Appworx/Patrol | ABCD178 agent is down (SERVERNAME Master), |
| | Agent/master Down | Agents are down: ABCDGG01 |
| 11 | Bounce appworx | Appworx master's need to be stopped for the bounce, |
| | | Bounce ABCDEF_PRD1 appworx master, |
| | | Need to stop master SERVERNAME for bounce |
| 12 | Bring appworx | Need to Shutdown Approx Agents in BOLT OVM |
| | agent/database/server | Servers, |
| | down | Please bring appworx master down |
| 13 | Change parameter | DBU: Please change parameter value of a program in |
| | | SERVERNAME, |
| | | Need to change parameter value SERVERNAME |
| | | instance |
| 14 | Change value | Appworx - Please change the prompt values, |
| | | Appworx- Please change the value in Substitute |
| | | Variable, |
| | | Please change the parameter value in mpcore |
| 15 | Change/modify schedule | Appworx - Please change the schedules, |
| | | DBU: Please change the schedule of a chain in |
| | | SERVERNAME, |
| | | Change the Payroll_Activity job schedule from Sunday |
| | | 2 PM to Friday 2 PM on Agent SERVERNAME |
| 16 | Check master | All jobs getting failed in SERVERNAME Master |
| | | Production. Please check n help on the same, |
| | | Appworx master SERVERNAME is slow, Jobs started |
| | | getting piled up. Please check on priority, |
| | | Global Enhancement Team: Please check the |
| | | agent(SERVERNAME) in Master SERVERNAME, |
| | | ‘SERVERNAME’ Master is too slow. Please check |
| 17 | Clear backlog | DBU: Clear Appworx Backlog, |
| | | DBU- Clear backlog in Production Appworx master: |
| | | SERVERNAME, |
| | | ABCDEF & XYZABC: Please clear the backlog, |
| | | Need backlogs for ABCXYZ master cleared |
| 18 | Create login | Need Appworx logins on, |
| | | Need to Create Appworx Login Creation on ABCDE |
| | | Master, |
| | | Please create remote login between XYZAB and |
| | | XYZGH |
| 19 | Printer management(ex; | Please add the printer name in the ABCXY file, |
| | create/remove, clear map | please check printer set up, |
| | printer etc.) | Please create entry of printer at backend |
| 20 | Information request | Can you please provide information on appworx |
| | | Metadata, |
| | | Please provide data and screenshot for failed jobs, |
| | | Please run the below query and provide data |
| 21 | Database bounce | Bounce of remote agent on ABCXYZ, |
| | | Database bounce activity, |
| | | Need to bounce BMS |
| 22 | Decommission Request | Decommission appworx ABCXYZ1 and install appworx |
| | | master XYZABC1, |
| | | Decommission agents in master ABCXYZ1 |
| 23 | Delete job/chain/module | (FBU GET Team: Enhancement) Need to delete backlog |
| | | from appworx, |
| | | Delete and re-submit the job XYZABC0150 in |
| | | ABCD01, |
| | | Delete the jobs in citstbi |
| 24 | Disable condition | Disable conditions for C_ABCDE_WEEKLY_LOAD, |
| | | Need to Disable conditions for |
| | | C_ABCDE_DAILY_LOAD in ABCDE001, |
| | | Please disable/enable the conditions |
| 25 | Disable/enable module | CTT => ABCDE01 => Need to disable the modules |
| | | Please check the notes, |
| | | Please enable/remove module XXYYZ0057 on |
| | | ABCDE01 Master, |
| | | Please disable some modules on Appworx Master: |
| | | ABCDE01 |
| 26 | Disable/enable single run | DBU: Please enable the single run for the chains in |
| | for chains | ABCD701, |
| | | XYZA01: Could you please disable single_run |
| | | checkbox for remote module |
| 27 | Enable Appworx job | DBU: Please enable jobs in DBU Production Appworx, |
| | | Enable Appworx job, |
| | | Please disable/enable the jobs as per ABCD outage |
| 28 | Export chain | Excel Export of Appworx Job details required. C_GL* |
| | | chains from stage and Production, |
| | | Please export Chain DBA_XXXXXX_CHAIN and |
| | | DBA_YYYYY_CHAIN |
| 29 | Failed Email Submit | Failed Email Submit |
| 30 | Found aborted jobs | : Found aborted jobs |
| 31 | FTP issue/request | CCI1P:Pls help run SFTP program at 9 pm CST to |
| | | resend INVOIC from appworx, |
| | | Please change the program name in master ABC201 in |
| | | XYZ_I2DM_ZXY_OB_ABCDE_GEX |
| 32 | Grant/remove Access | App works access, |
| | issue/request | Job scheduling elevated access, |
| | | Revoke My access |
| 33 | Inactivate queue | Please inactivate the queue ABCXYZ26 on master |
| | | ABCXYZ. |
| 34 | Software Install/uninstall | Need OAE agent installed for ABC1XA instance, |
| | request | Need Remote agent installed, |
| | | Please install appworx 6 and then 8 on SERVERNAME |
| 35 | Jobs running slow | All PBI jobs running for long time, |
| | | All the Jobs in SERVERNAME are running slow, |
| | | Jobs are taking more time to complete in |
| | | SERVERNAME master |
| 36 | Kill requests/jobs | (Global Enhancement Team - DEP1S)Please kill the |
| | | requests running for ‘XXYY0305_DEP_CH’ on |
| | | ABCDX01, |
| | | ABCDX01: Please kill XXYYZZ_RMEP_20_CH, |
| | | Please kill long running job XXYY0943 in |
| | | SERVERNAME master |
| 37 | Kill session/job | SERVERNAME: Job stuck at kill status, |
| | | AABBC01 - Need to remove kill request from backlog |
| 38 | Login issue | Appworx - Unable to open login screen for ABCD |
| | | Appworx Production, |
| | | CTT: Provide appworx login to ABCDE01, |
| | | Not getting the login screen for XYZAB |
| 39 | Migration issue/request | Appworx migration from production(SERVERNAME) |
| | | to development (SERVERNAME), |
| | | Appworx - SAMPLE CHANGE |
| | | REQUEST000000086680 - Migration of chains, |
| | | CGL Migration - Migrate all the workflows from UAT |
| | | to Dev |
| 40 | Password Management | Appworx: Password reset, |
| | (ex; reset, expiry, | Provide account password, |
| | troubleshooting etc.) | Appworx: Please reset my password to below Masters |
| 41 | Please check the job | In SERVERNAME master job is running from long time |
| | | please check, |
| | | Please check completed jobs showing as running in |
| | | SERVERNAME01, |
| | | Please check the aborted job |
| 42 | Printer management(ex; | Add printer in appworx instances: ABCDXYZ, |
| | create/remove, clear map | New printer setup, |
| | printer etc.) | Please correct the setup of the printer in ABCDXYZ1 |
| | | Appworx |
| 43 | Provide access to server | Add exception to |
| | | CFS_ARC_US_604_0078XYZ_S_CH, |
| | | Keep exception in XYZABCD Master for |
| | | SAS_ABCD_LOAD, |
| | | Please create exception in ABCDXYZ |
| 44 | Provide list of jobs | Kindly provide list of jobs running, |
| | | Please provide list of all Jobs live for BI from Appworx |
| 45 | Provide logs | Remove Reliability jobs in backlogs present in STAGE |
| | | appworx Master - ABCD01 |
| 46 | Provide/remove access | Access on following production appworx for |
| | | performance monitoring, |
| | | Access for COLS & BYE on ABCXYZ01, |
| | | Access required on Appworx |
| 47 | Put job on hold | A job with job ID 7812595 is on hold in ABCXYZ0, |
| | | Please hold off batch job on July 8, |
| | | Please hold off submit job on Jun. 10th 2013 |
| 48 | Quarterly Appworx | Q3_2013_LS3.2.3_Apprworx-Findings |
| | findings | |
| 49 | Quarterly review | Q3 2013 User List for Appworx |
| 50 | Reboot Activity | BMS CCPI Production server reboot activity, |
| | | Immediate server reboot of SERVERNAME, |
| | | Server Reboot on Saturday November 23 at 6:30 AM |
| | | EST |
| 51 | Remove Exception | Need to remove exception, |
| | request | Please remove exception from job |
| | | XYZ_RSS_SUBMIT_MD |
| 52 | Remove parameter | Please remove parameter from SERVERNAME from |
| | | ABCDE01 master, see notes |
| 53 | Reset module | ABCDE01: Please reset module, |
| | | Please reset the aborted module in Master :- ABCDE01 |
| 54 | Reset the job | Appworx job to reset, |
| | | ABCDE01: Need to reset aborted job |
| | | XXYYZ0366_DEP_30_MD job id 6560462 |
| 55 | Restart agent | Please clear the backlog and restart the agent |
| 56 | Schedule chain | DBU: Please add the schedule the chains in |
| | | XXYYZ701, |
| | | XXYYZ01 :- Please enable the schedule of the chain in |
| | | XXYYZ01, |
| | | Please schedule chains on XXYYZ01 |
| 57 | Schedule job | Appworx team to reschedule the Jobs, |
| | | XXYYZ01: Please schedule the appworx jobs on |
| | | XXYYZ01, |
| | | Please disable the schedule jobs marked in the excel |
| | | sheet in the master XXYYZZ01 and App NGXYZ |
| 58 | Skip the chain scheduled | Need to Skip the chain scheduled on 25 AUG. 2013 |
| | | (mentioned in notes) from ABCDE01 master, |
| | | Please skip the chain for 24th-AUG.-13 run on ABCDE |
| | | Master |
| 59 | Slowness issue | Appworx response is slow, |
| | | Appworx slowness issue - Master ABCDE001, |
| | | ABCDE01 - Chains running slow, |
| | | ABCXYZ01 - Master responding very slow |
| 60 | SOX review/audit | CAR CIS 5271 - SOX LS3.2.3 - Please execute the |
| | | following query and send output, and system date, |
| | | Please get this information for Q3 2013 SOx Audit for |
| | | APM#669 LS3.2.3, |
| | | ABCD01: Q4 Review SOX Audit Finding (LS3.2.3) |
| 61 | Space issue | Please clear some space in aw_edw mount point in |
| | | SERVERNAME server |
| 62 | Stop agent/master | ABCD Activity: Please stop and start the agent |
| | | AABBCC01 and AABBCC14, |
| | | Kindly stop appworx master running on SOMS |
| | | SERVERNAME, |
| | | ABCDXYZ −> Can you please stop the appworx agent |
| 63 | Unable to view job | ABCXYZ02: not able to view Module's information, |
| | | Not able to view all jobs in ABCXY and ABCXY |
| 64 | Upgrade appworx | Please upgrade appworx master ABCXYZ-1 during |
| | | ACCOUNT NAME Atlantic go live week |
| 65 | Utilization Issue (Alerts | File system orabackup is 95.007300% full on |
| | related to CPU, Memory, | SERVERNAME - IP ADDRESS Threshold 95% < |
| | Disk, Network etc.) | 95.007300% < |

TABLE 20
Examples of low complexity activity inWeb

| SI. No | Activity/Category/Tasks | Example of Ticket Summary |
|---|---|---|
| 1 | Add jar files | Add jar files - WAS 7 Staging environment (http:// |
| | | SERVERNAME), |
| | | Add JAR to shared library of Webpartsdev |
| 2 | Application issue | Application not working on DEV, |
| | | Please check issue with the application, unable to start |
| 3 | Clear cache | Need to clear server cache for http:// SERVERNAME |
| | | /tuition/, |
| | | Please Clear Server Cache |
| 4 | Create group | As part of Part Pricing project a new LDAP group needs |
| | | to be created in PROD region, |
| | | Please create a LDAP group for CTAS on dev where all |
| | | valid ACCOUNT NAME wwid can access |
| 5 | Information request | Please provide information, |
| | | Please provide information for SOx CC2.1 Q3 2013 |
| | | APM 669 |
| 6 | Decommission Request | Decommission ACCOUNT NAME Engines website, |
| | | Need to Decommission DEV GSA collection |
| | | EBU_SERVERNAME_COLLECTION and |
| | | EBU_SERVERNAME_ABCZYGFA |
| 7 | Deployment issue | Deploy EAR on SERVERNAME |
| 8 | Deployment request | DCX Production EAR deployment, |
| | | ECW Stag Deployment, |
| | | Please deploy mentioned EAR on STG server |
| 9 | Device not accessible | Ariba Staging application is not accessible after Patch |
| | | upgrade yesterday, |
| | | XYZA Dev is not accessible. |
| 10 | Grant/remove Access | Access issue, |
| | issue/request | Access permission require, |
| | | All users cant access http://SERVERNAME |
| 11 | Internal server error | Internal server error after deployment in lrs-dev, |
| | | SESAdmin application on stg is giving ‘Internal server |
| | | error’ |
| 12 | Migration issue/request | Migrate EAR file, |
| | | Please migrate EAR on production for MaCTrack |
| | | application, |
| | | Migrate PRS EAR from dev to stage |
| 13 | Move EAR from Stage | Move EAR to Stg for IAM Profitability, |
| | | Need to move EAR from Stage to Prod for RPV |
| 14 | Promote EAR from Dev | Please promote below EAR from Dev to Stage |
| | to Stage | |
| 15 | Provide Application and | Application and jvm logs for Dutycycle, |
| | jvm logs | Application and jvm logs for Dutycycle |
| | | SERVERNAME, SERVERNAME01 |
| 16 | Provide logs | Need latest logs, |
| | | Need Log files, |
| | | Need Logs for Tuition assistance application on DEV |
| 17 | Reboot Activity | **********************URGENT********** stg |
| | | app server is very slow/down. Can you please restart it, |
| | | Need server restart, |
| | | please clear the cache and restart the app server |
| 18 | Restart Application | Clear cache and restart jvm for IT Time Track |
| | | application. |
| 19 | Slowness issue | Apps on SERVERNAME very slow |

Upon identifying, the activity complexity module 212 may configure a activity complexity database based on a plurality of low complexity activities identified across industry segments and technology tracks in an information technology framework. In one example the data based may be relation database.

### Team Module 214

In the implementation, the team module 214 may obtain second input data. The second input may comprises human resource data, skill data, and resource work experience data, training data, education data and volume of ticket to be resolved data. Further, the team module 214 may store the second input data in system data 222.

Further to obtaining the second input data, the team module 214 may form the low complexity ticket team based on the second input data and a predefined resource identification criterion. In one implementation, the team module 214 may select the human resources from the human resource data and form one or more teams. The predefined identification criterion comprises the total amount of work experience, education data, and volume of ticket to resolve, primary skill of the human resource in a given technology, tenure in a technology. In one example, the total amount of work experience may be 2-4 years, education data may be engineering, and volume of ticket to resolve may be 5 per day, primary skill of the human resource in a given technology may be UNIX™; tenure in a technology may be 6 months. Furthermore the team module 214 may store the team structure or list of team members in system data 222.

### Work Process Module 216

In the implementation, the work process module 216 may obtain third input data. The third input may comprises project data, and customer data. Further, the work process module 216 may store the third input data in system data 222.

Further to obtaining third input data, the work process module 216 may define the low complexity resolution process for the low complexity ticket to be performed by the low complexity ticket team. The low complexity resolution process may be based on the third input data and a predefined resolution criterion. The predefined resolution criterion comprises time required for resolution of the ticket. In one example the time required for resolution of the ticket may be 1 hour. Further, in one example the low complexity resolution process may comprises escalation rules and swing rules. An escalation rule may be understood as transferring the ticket to a subject matter expert when ticket 50% time required for resolution is passed. A Swing rules may be understood transferring the ticket to a subject matter expert when the current resource capacity is not able to handle ticket volume.

Further, the work process module 216 may store the low complexity resolution process in system data 222.

### Resolution Module 218

In the implementation the resolution module 218 may receive a ticket for resolution from a customer in the information technology framework. The ticket comprises at least one of an issue, an error and a problem being faced by the customer. The resolution module 218 may store the ticket in system data 222.

Upon receiving the ticket, the resolution module 218 may classify the ticket as a low complexity activity or a non-low complexity activity. In one example the classification may be based on a comparison of the ticket with the plurality of low complexity activities stored in the activity complexity. Further, the tickets classified as low complexity activity may be stored in the system data 222. In one other example, the tickets classified as non-low complexity activity may be forwarded to a subject matter expert's team for resolution.

Further to classification of the ticket, the resolution module 218 may assign the ticket classified as the low complexity activity to the low complexity ticket team for providing a resolution to the ticket. The low complexity ticket team is at least one of a cross functional and cross technology team.

Finally after assignment of the ticket classified as low complexity activity, the resolution module 218 may enable generation of the resolution. The resolution may be based on a low complexity resolution process for providing the resolution to the ticket. The low complexity resolution process may be executed by the low complexity ticket team.

Exemplary embodiments discussed above may provide certain advantages. Though not required to practice aspects of the disclosure, these advantages may include those provided by the following features.

Some embodiments of the system and the method enables improved consistency of response through building the low complexity team on end to end delivery of pooling common activities across different technology.

Some embodiments of the system and the method reduce follow-ups.

Some embodiments of the system and the method reduced skill variability by aligning human resources to functions and technologies (right work to right skill) ensuring retention of human resources.

Some embodiments of the system and the method enable focused effort on more complex and urgent tasks.

Some embodiments of the system and the method enable freeing up the time of senior technical resources and let them invest it in doing High complexity analysis, mentoring future planning for capacity and improvement of services.

Some embodiments of the system and the method enable improved employee motivation through opportunity to develop deeper expertise on core skill areas, leading to overall improvement in resource quality and job satisfaction

Some embodiments of the system and the method enable avoid unnecessary escalations.

Some embodiments of the system and the method enable sharing of experience between the team members

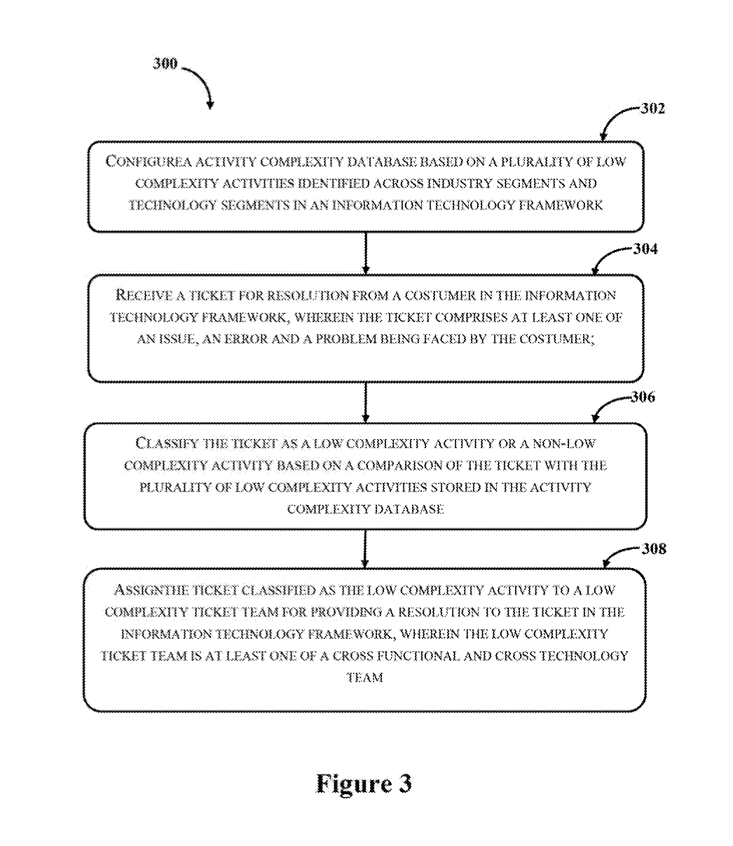

Referring now to FIG. 3, a method 300 for providing a resolution to a ticket in a lean information technology frame work is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, an activity complexity database is configured. The activity complexity database based on a plurality of low complexity activities identified across industry segments and technology tracks in an information technology framework. In an implementation, the activity complexity module 212 may configure the activity complexity database based on a plurality of low complexity activities and store the activity complexity database in system data 222.

At block 304, a ticket for resolution is received from a customer in the information technology framework. The ticket comprises at least one of an issue, an error and a problem being faced by the customer. In the implementation, the resolution module 218 may receive a ticket for resolution and store the ticket in system data 222.

At block 306, the ticket may be classified as a low complexity activity or a non-low complexity activity based on a comparison of the ticket with the plurality of low complexity activities stored in the activity complexity database. In the implementation, the resolution module 218 may classify the ticket as a low complexity: activity or a non-low complexity activity and store the ticket in system data 222. In one more implementation the resolution module 218 may provide the activity complexity database to a low complexity ticket team for classification of the ticket in to a low complexity activity or a non-low complexity activity.

At block 308, the ticket classified as the low complexity activity may be assigned to a low complexity ticket team for providing a resolution to the ticket in the information technology framework. The low complexity ticket team is at least one of a cross functional and cross technology team. In the implementation, the resolution module 218 may assign the ticket assigned to a low complexity ticket team for providing a resolution to the ticket in the information technology framework and store the resolution in system data 222.

Exemplary embodiments discussed above may provide certain advantages. Though not required to practice aspects of the disclosure, these advantages may include for providing a resolution to a ticket in a lean information technology framework. Although implementations for methods and system for providing a resolution to a ticket in a lean information technology frame work have been described in language specific to structural features and/or methods, it is to be understood that the appended claims are not necessarily limited to the specific features or methods described. Rather, the specific features and methods are disclosed as examples of implementations for providing a resolution to a ticket in a lean information technology framework.

1. A method for providing a resolution to a ticket in an lean information technology framework, the method comprising:
configuring, by a processor, a activity complexity database based on a plurality of low complexity activities identified across industry segments and technology tracks in an information technology framework;
receiving, by the processor, a ticket for resolution from a customer in the information technology framework, wherein the ticket comprises at least one of an issue, an error and a problem being faced by the customer;
classifying, by the processor, the ticket as a low complexity activity or a non-low complexity activity based on a comparison of the ticket with the plurality of low complexity activities stored in the activity complexity database; and
assigning, by the processor, the ticket classified as the low complexity activity to a low complexity ticket team for providing a resolution to the ticket in the information technology framework, wherein the low complexity ticket team is at least one of a cross functional and cross technology team.

2. The method of claim 1 further comprising:
generating, by the processor, there solution based on a low complexity resolution process for providing the resolution to the ticket, wherein the low complexity resolution process is executed by the low complexity ticket team.

3. The method of claim 1 further comprising:
obtaining, by the processor, first input data, wherein the first input data comprises historical activities data, activities resolution trend data, activities time to resolve data, and activities average monthly volume; and
identifying, by the processor, the one or more low complexity activities for each of the industry segments and technology tracks based on the first input data and a predefined activities identification criterion, wherein the predefined activities identification criteria comprises type of environment, impact on environment, and time to resolve the activities.

4. The method of claim 1 further comprising:
obtaining, by the processor, second input data, wherein the second input comprises human resource data, skill data, resource work experience data, training data, education data and volume of ticket to be resolved data; and
forming, by the processor, the low complexity ticket team based on the second input data and a predefined resource identification criterion, wherein the predefined identification criterion comprise the total amount of work experience, education data, and volume of ticket to resolved.

5. The method of claim 2 further comprising:
obtaining, by the processor, third input data, wherein the third input comprises project data, and customer data; and
defining, by the processor, the low complexity resolution process resolution process for the low complexity ticket to be performed by the low complexity ticket team based on the third input data and a predefined resolution criterion; wherein the predefined resolution criterion comprises time required for resolution of the ticket.

6. A system for providing a resolution to a ticket in an lean information technology framework, the system comprising:
a memory; and
a processor coupled to the memory, wherein the processor is capable of executing instructions stored in the memory, to perform steps of:
configuring a activity complexity database based on a plurality of low complexity activities identified across industry segments and technology tracks in an information technology framework;
receiving a ticket for resolution from a customer in the information technology framework, wherein the ticket comprises at least one of an issue, an error and a problem being faced by the customer;
classifying the ticket as a low complexity activity or a non-low complexity activity based on a comparison of the ticket with the plurality of low complexity activities stored in the activity complexity database; and
assigning the ticket classified as the low complexity activity to a low complexity ticket team for providing a resolution to the ticket in the information technology framework, wherein the low complexity ticket team is at least one of a cross functional and cross technology team.

7. The system of claim 6 further comprising:
generating there solution based on a low complexity resolution process for providing the resolution to the ticket, wherein the low complexity resolution process is executed by the low complexity ticket team.

8. The system of claim 6 further comprising:
obtaining first input data, wherein the first input data comprises historical activities data, activities resolution trend data, activities time to resolve data, and activities average monthly volume; and
identifying the one or more low complexity activities for each of the industry segments and technology tracks based on the first input data and a predefined activities identification criterion, wherein the predefined activities identification criteria comprises type of environment, impact on environment, and time to resolve the activities.

9. The system of claim 6 further comprising;
obtaining second input data, wherein the second input comprises human resource data, skill data, resource work experience data, training data, education data and volume of ticket to be resolved data; and
forming the low complexity ticket team based on the second input data and a predefined resource identification criterion, wherein the predefined identification criterion comprise the total amount of work experience, education data, and volume of ticket to resolved.

10. The system of claim 7 further comprising:
obtaining third input data, wherein the third input comprises project data, and customer data; and
defining the low complexity resolution process resolution process for the low complexity ticket to be performed by the low complexity ticket team based on the third input data and a predefined resolution criterion; wherein the predefined resolution criterion comprises time required for resolution of the ticket.

11. A non-transitory computer program product having embodied thereon a computer program for providing a resolution to a ticket in an lean information technology framework, the computer program product storing instructions, the instructions comprising instructions for:
obtaining first input data for one or more industry segments and one or more technology tracks, wherein the first input data comprises historical activities data, activities resolution trend data, activities time to resolve data, and activities average monthly volume;
identifying the one or more low complexity activities for each of the industry segments and technology tracks based on the first input data and a predefined activities identification criterion, wherein the predefined activities identification criteria comprises type of environment, impact on environment, and time to resolve the activities;
configuring a activity complexity database based on a plurality of low complexity activities identified across industry segments and technology tracks in an information technology framework;
receiving a ticket for resolution from a customer in the information technology framework, wherein the ticket comprises at least one of an issue, an error and a problem being faced by the customer;
classifying the ticket as a low complexity activity or a non-low complexity activity based on a comparison of the ticket with the plurality of low complexity activities stored in the activity complexity database;
assigning the ticket classified as the low complexity activity to a low complexity ticket team for providing a resolution to the ticket in the information technology framework, wherein the low complexity ticket team is at least one of a cross functional and cross technology team; and
generating the resolution based on a low complexity resolution process for providing the resolution to the ticket, wherein the low complexity resolution process is executed by the low complexity ticket team.

12. A non-transitory computer program product of claim 11 further comprising:
obtaining second input data, wherein the second input comprises human resource data, skill data, resource work experience data, training data, education data and volume of ticket to be resolved data;
forming the low complexity ticket team based on the second input data and a predefined resource identification criterion, wherein the predefined identification criterion comprise the total amount of work experience, education data, and volume of ticket to resolved;
obtaining third input data, wherein the third input composes project data, and customer data; and
defining the low complexity resolution process resolution process for the low complexity ticket to be performed by the low complexity ticket team based on the third input data and a predefined resolution criterion; wherein the predefined resolution criterion comprises time required for resolution of the ticket.
